(19) United States
(12) Patent Application Publication
(10) Pub. No.: US 2019/0081469 A1
(43) Pub. Date: Mar. 14, 2019

(54) CLAMP

(71) Applicant: Hubbell Incorporated, Shelton, CT (US)

(72) Inventors: Devan Emily Shea, Hampstead, NH (US); Sarah Jane Parsons, Medford, MA (US)

(21) Appl. No.: 16/125,090

(22) Filed: Sep. 7, 2018

Related U.S. Application Data
(60) Provisional application No. 62/555,914, filed on Sep. 8, 2017.

(51) Int. Cl. H02G 3/32; H02G 1/04

(52) U.S. Cl. CPC H02G 3/32; H02G 1/04

(57) ABSTRACT

A clamp includes a body, a channel, an opening and a clamping member. The body includes a first end, a second end, a first side, and a second side. The first side extends between the first end and the second end. A longitudinal axis extends between the first end and the second end. The channel extends through the body in a direction transverse to the longitudinal axis, and the channel includes a plurality of curved inner surfaces having different radii of curvature. The channel is positioned adjacent the first end. The opening extends between the first end of the body and the channel, and permits a portion of a cable to be laterally inserted into the channel. The clamping member is positioned adjacent the first side of the body and is capable of engaging a support member. The clamping member is configured to bias the support member against the first side.

### CROSS-REFERENCE TO RELATED APPLICATION

This application claims the benefit of co-pending, prior-filed U.S. Provisional Patent Application No. 62/555,914, filed Sep. 8, 2017, the entire contents of which are incorporated by reference.

### BACKGROUND

The present disclosure relates to clamp devices, and particularly to a clamp for cables.

### SUMMARY

In one independent aspect, a clamp includes a body, a channel, an opening, and a clamping member. The body includes a first end and a second end. The body further includes a first side and a second side. The first side extends between the first end and the second end. A longitudinal axis extending between the first end and the second end. The channel extends through the body in a direction transverse to the longitudinal axis, and the channel includes a plurality of curved inner surfaces having different radii of curvature. The channel is positioned adjacent the first end. The opening extends between the first end of the body and the channel, and the opening is configured to permit a portion of a cable to be laterally inserted into the channel. The clamping member is positioned adjacent the first side of the body and is capable of engaging a support member. The clamping member is configured to bias the support member against the first side.

In another independent aspect, a clamp includes a body, a first channel, a first opening, a second channel, a second opening, a first clamping member, and a second clamping member. The body includes a first end and a second end. The body further includes a first side and a second side. The first side extends between the first end and the second end. The longitudinal axis extends between the first end and the second end. The first channel extends through the body in a direction transverse to the longitudinal axis. The first channel is positioned adjacent the first end. The first opening extends between the first end of the body and the first channel. The first opening is configured to permit a portion of a cable to be laterally inserted into the first channel. The second channel extends through the body in a direction transverse to the longitudinal axis. The second channel is positioned adjacent the second end and substantially parallel to the first channel. The second opening extends between the second end of the body and the second channel, and the second opening is configured to permit a portion of a cable to be laterally inserted into the second channel. The first clamping member is positioned adjacent the first side of the body and exerts a biasing force against the first side. The second clamping member is positioned adjacent the second side of the body and exerts a biasing force against the second side.

Other aspects will become apparent by consideration of the detailed description and accompanying drawings.

### BRIEF DESCRIPTION OF THE DRAWINGS

FIG. 1 is a perspective view of a clamp according to one embodiment.

FIG. 2 is a front view of the clamp of FIG. 1.

FIG. 3 is a side view of the clamp of FIG. 1.

FIG. 4 is another side view of the clamp of FIG. 1.

FIG. 5 is a perspective view of the clamp of FIG. 1 including cables.

FIG. 6 is another perspective view of the clamp of FIG. 5.

FIG. 7 is a top view of the clamp of FIG. 5.

FIG. 8 is a bottom view of the clamp of FIG. 5.

FIG. 9 is a skewed front view of the clamp of FIG. 5.

FIG. 10 is another perspective view from a side of the clamp of FIG. 5.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

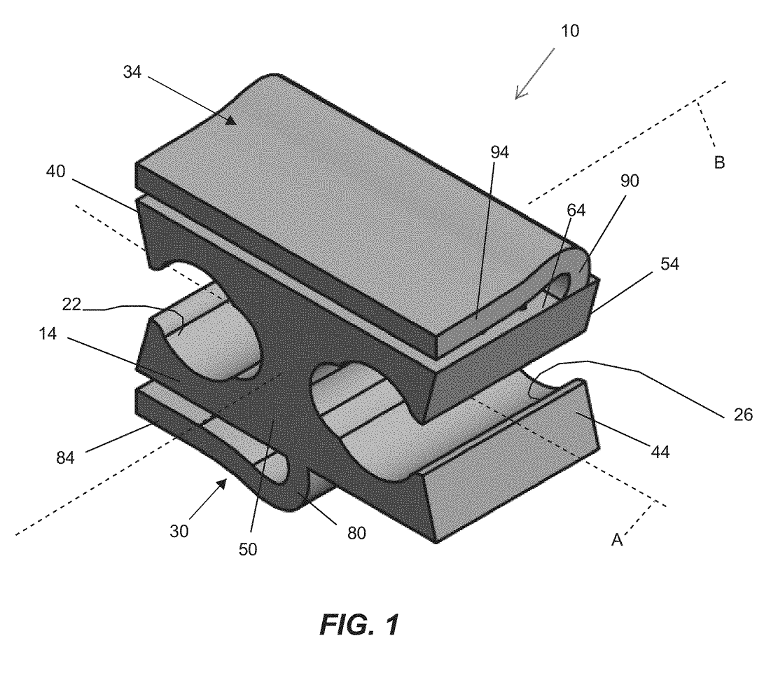

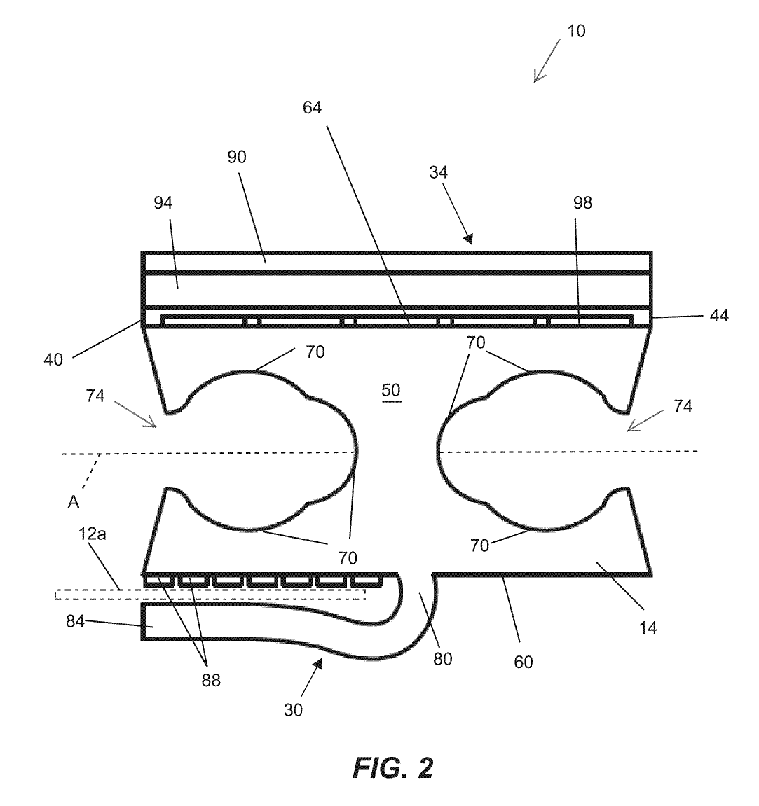

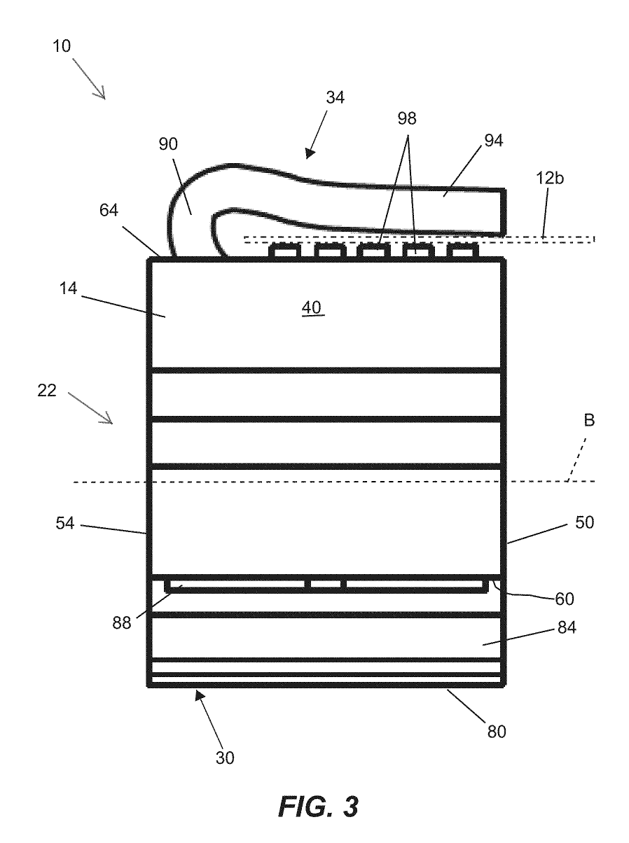

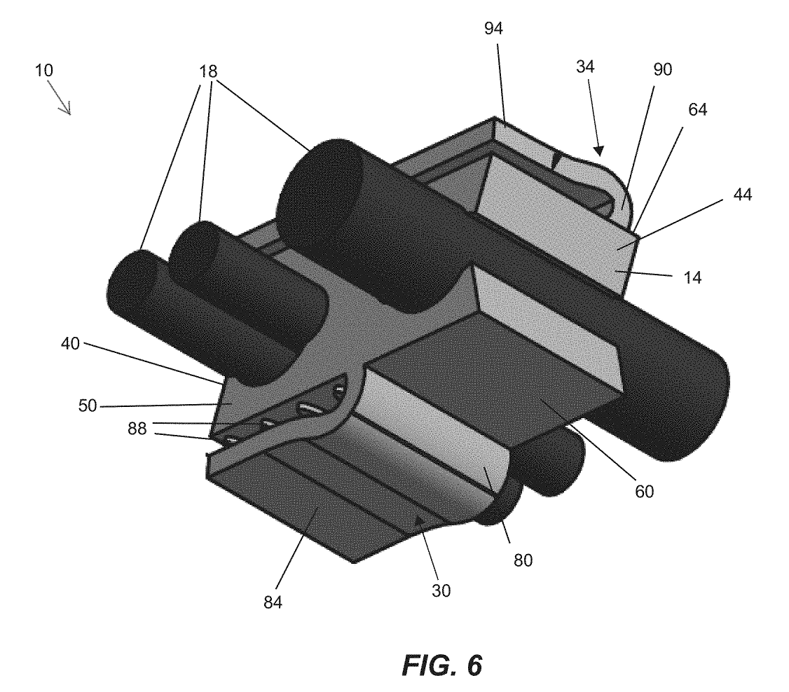

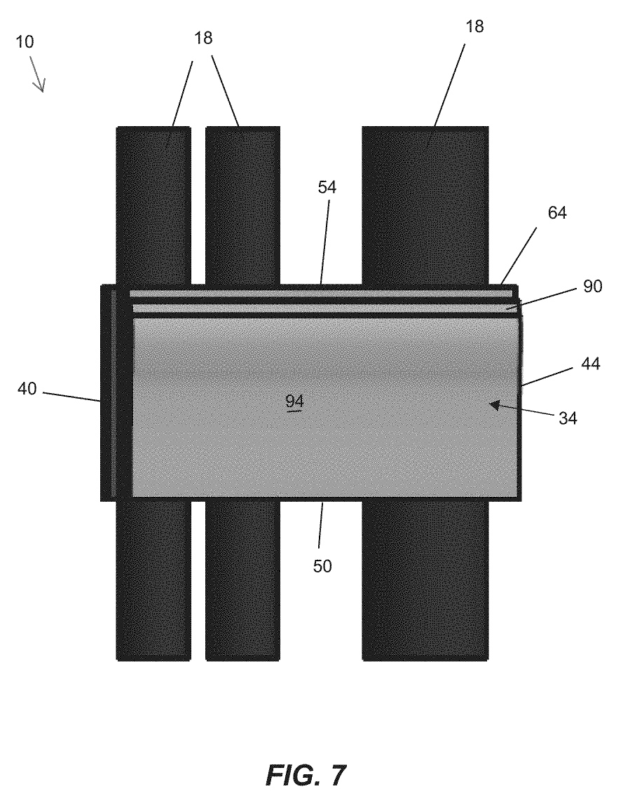

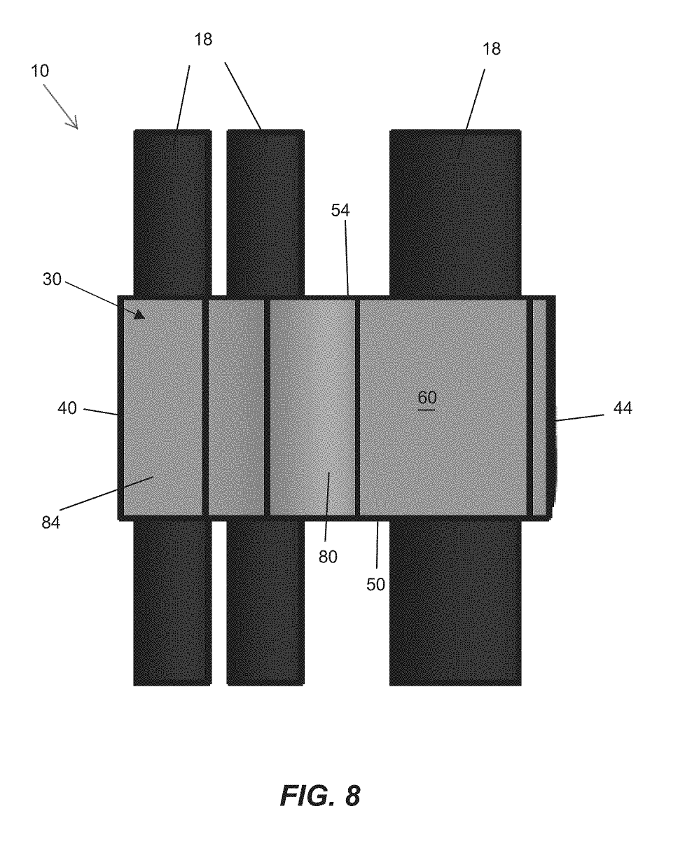

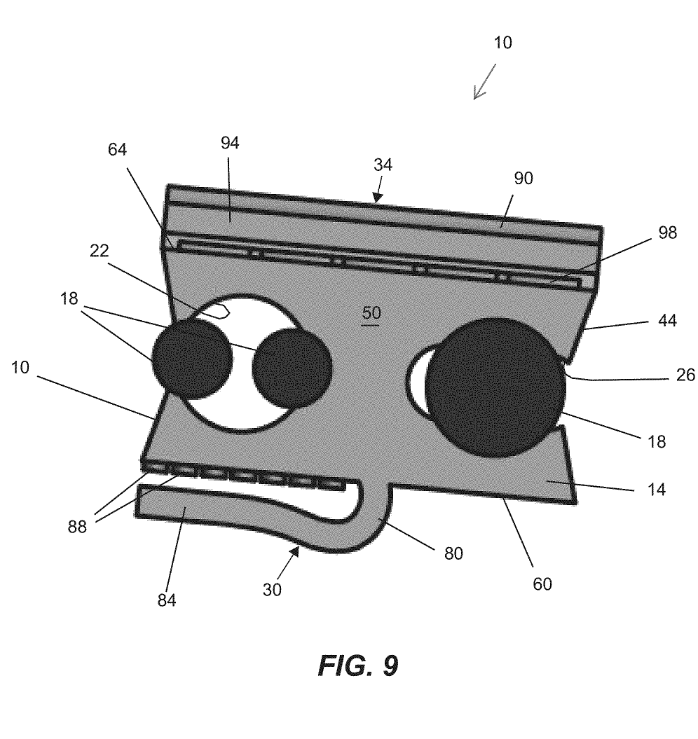

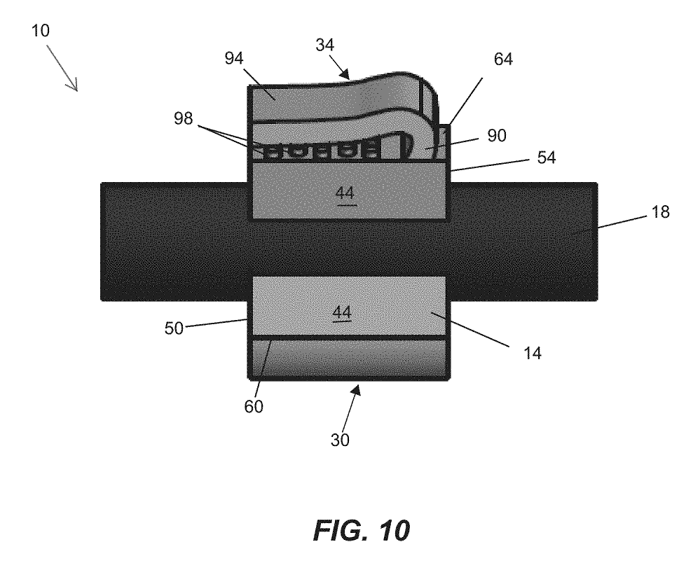

FIGS. 1-10 illustrate a clamp 10 for coupling one or more cables 18 to a support member 12 (FIGS. 2 and 3). The clamp 10 is configured to engage the support member and also receive and retain a portion of the cables 18. In the illustrated embodiment, the clamp 10 includes a body 14, a first channel 22, a second channel 26, a first clamping member or first coupling member 30, and a second clamping member or second coupling member 34.

As shown in FIGS. 1-4, the body 14 has a first end 40 and a second end 44. A first axis or longitudinal axis A extends through the body 14 between the first end 40 and the second end 44. The body 14 further has a first surface 50 and a second surface 54. A second axis B extends through the body 14 between the first surface 50 and the second surface 54. In addition, the second axis B is substantially perpendicular to the first axis A. In the illustrated embodiment, the body 14 is fabricated from a nylon material. Forming the body 14 from nylon material avoids sharp edges, thereby avoiding damage to insulation of the cables 18. In other embodiments, the body 14 may be fabricated from a different material, and/or may have a different shape than that which is illustrated.

Referring to FIG. 2, the first channel 22 extends between the first surface 50 and the second surface 54, and is oriented generally parallel to the second axis B. In the illustrated embodiment, the first channel 22 is positioned adjacent the first end 40 of the body 14, and the first channel 22 is open to the first end 40. The second channel 26 extends between the first surface 50 and the second surface 54 and is oriented generally parallel to the second axis B. In the illustrated embodiment, the second channel 26 is positioned adjacent the second end 44 of the body 14. The illustrated second channel 26 is substantially parallel to the first channel 22. Also, in the illustrated embodiment, the first and second channels 22, 26 include multiple semi-circular portions 70 extending between the first surface 50 and the second surface 54 of the body 14. The illustrated first and second channels 22, 26 include two semi-circular portions 70.

Referring to FIG. 2, the first channel 22 includes an opening 74 adjacent the first end 40 and the second channel 26 includes an opening 76 adjacent the second end 44. The cables 18 (FIG. 1) may be received through the openings 74, 76 to be positioned in the first and second channels 22, 26, respectively. Furthermore, the nylon body 14 may be resilient or pliable or elastic such that the portions of the body 14 around the openings 74, 76 are configured to widen to receive the cables 18 and close over the cables 18 once the cables are positioned in the first and second channels 22, 26. In other words, the first and second channels 22, 26 substantially enclose and hold a portion of the cables 18 in the body 14 of the clamp 10.

As shown in FIGS. 1 and 2, the body 14 has a first side 60 and a second side 64 opposite the first side 60. The first coupling member 30 is positioned on the first side 60. The first coupling member 30 includes a connecting portion 80 and a leg portion 84. The connecting portion 80 protrudes from the first side 60. The illustrated connecting portion 80 and the leg portion 84 has a width coextensive with a distance between the first surface 50 and the second surface 54, and the connecting portion 80 is attached to the first side 60 at a position generally in the middle of the first side 60. In other embodiments, the connecting portion 80 of the first coupling member 30 may have a different width and may be located at a different position. The leg portion 84 is coupled to the connecting portion 80 in a cantilevered manner. The leg portion 84 is resilient and is oriented to clamp an object, such as the support member 12, against the first side 60. The illustrated leg portion 84 of the first coupling member 30 extends toward the first end 40 of the body 14 in a direction generally parallel to the first axis A. In other embodiments, the connecting portion 80 may be positioned in a different location, and/or the leg portion 84 may extend in a different direction. For example, the leg portion 84 may extend toward the second end 44.

As shown in FIG. 2, the body 14 includes a first set of teeth or projections 88 extending from the first side 60 of the body 14. In the illustrated embodiment, the first set of projections 88 are positioned between the first side 60 and the leg portion 84 of the first coupling member 30. The first coupling member 30 is configured to secure the clamp 10 to the support member or structure between the first side 60 and the leg portion 84 of the first coupling member 30. The projections 88 can inhibit sliding of the body 14 of the clamp 10 relative to the support member.

As shown in FIGS. 1-4, the second coupling member 34 is positioned the second side 64 of the body 14 (e.g., on an opposite side of the body 14 relative to the first coupling member 30). The second coupling member 34 includes a connecting portion 90 and a leg portion 94 similar to the connecting portion 80 and the leg portion 84 of the first coupling member 30. The connecting portion 90 protrudes from the second side 64. The illustrated connecting portion 90 and the leg portion 94 have a length that is substantially coextensive with a distance between the first end 40 and the second end 44, and the connecting portion 90 is attached to the second side 64 at a position generally adjacent the second surface 54 of the body 14. In other embodiments, the connecting portion 90 of the second coupling member 34 may have a different length and may be located at a different position. The leg portion 94 is coupled to the connecting portion 90 in a cantilevered manner. The leg portion 94 is resilient and is oriented to clamp an object, such as a support member, against the second side 64. The illustrated leg portion 94 of the second coupling member 34 extends toward the first surface 50 of the body 14 in a direction generally parallel to the second axis B. In other embodiments, the connecting portion 90 may be positioned in a different location, and/or the leg portion 94 may extend in a different direction. For example, the connecting portion 94 may be positioned near the first surface 50 of the body 14 and the leg portion 94 may extend toward the second surface 54.

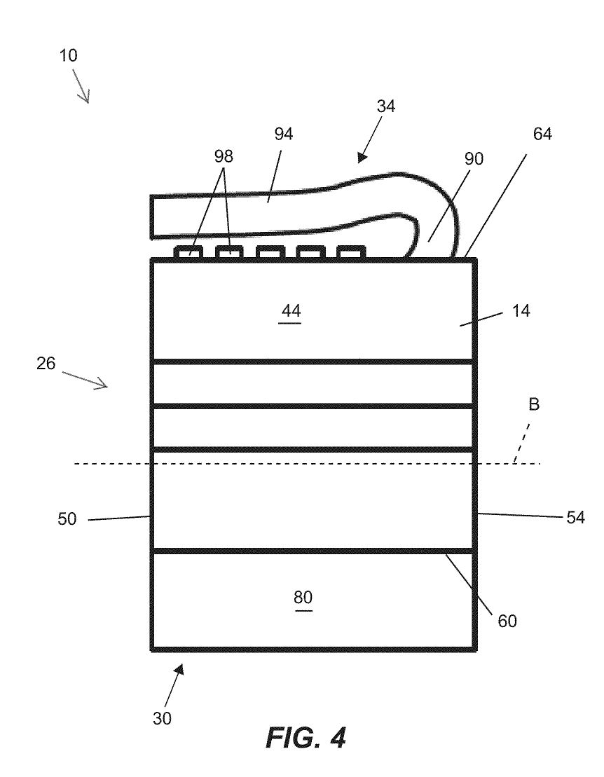

As shown in FIGS. 3 and 4, the body 14 includes a second set of teeth or projections 98 extending from the second side 64 of the body 14. In the illustrated embodiment, the second set of projections 98 are positioned between the second side 60 and the leg portion 94 of the second coupling member 34. The second coupling member 34 is configured to secure the clamp 10 to the support member between the second side 64 and the leg portion 94 of the second coupling member 34. The projections 98 can inhibit sliding of the body 14 of the clamp 10 relative to the support member.

FIGS. 1-10 show the first and second coupling members 30, 34 extending in a cantilevered manner and supported on the first and second sides 60, 64 of the body 14, respectively. The first and second coupling members 30, 34 are configured to secure (i.e., clamp) the clamp 10 to the support member. The support member may slide between the leg portion 84, 94 of the first or second coupling members 30, 34 and the first or second sides 60, 64 of the body 14, respectively. Specifically, the leg portions 84, 94 of the first and second coupling members 30, 34 extend in different directions relative to each other. Stated another way, the first leg portion 84 forms a space or opening along the first side 60 that is configured to receive a support member 12a (FIG. 2) in a direction parallel to the first axis A, and the second leg portion 94 forms a space or opening along the second side 64 that is configured to receive a support member 12b (FIG. 3) in a direction parallel to the second axis B. Stated in yet another way, the first leg portion 84 exerts a clamping force against the first side 60 in a direction that is substantially parallel to the first axis A, and the second leg portion 94 exerts a clamping force against the second side 64 in a direction that is substantially perpendicular to the second axis B.

The clamp 10 can be secured in different orientations relative to the support member. In some embodiments, the first and second channels 22, 26 extend in a direction parallel to the first axis A. In some embodiments, the first and second channels 22, 26 extend in a direction parallel to a direction in which the second leg portion 94 extends from the second connecting portion 90, and perpendicular to a direction in which the first leg portion 84 extends from the first connecting portion 80. As a result, the clamp 10 can engage cables oriented in various directions relative to the support member and secure them to the support member

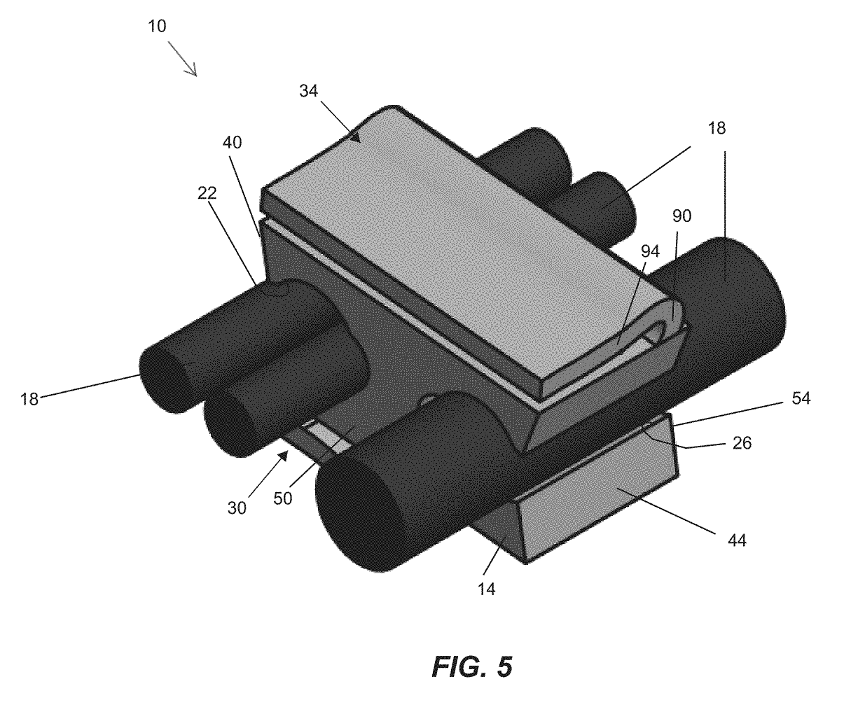

As shown in FIGS. 5-10, the clamp 10 is configured to receive cables 18 of different sizes. Specifically, the first channel 22 and the second channel 26 are configured to receive cables 18 having a dimension within a predetermined range. For example, in FIG. 5, the first channel 22 receives two cables 18 each having a relatively small diameter and the second channel 26 receives one cable 18 having a relatively large diameter. In the illustrated embodiment, the two smaller diameter cables 18 are PV cables and the larger diameter cable 18 is a trunk cable. In other embodiments, the first and second channels 22, 26 may receive one or more cables 18. Furthermore, the first channel 22 may receive a cable 18 having a larger diameter than the cable 18 received by the second channel 26.

The first or second coupling members 30, 34 secure the clamp 10 to the support member. The cables 18 can be laterally inserted through the openings 74, 76 adjacent the ends 40, 44, respectively of the body 14. The first and second channels 22, 26 receive a portion of the cables 18, thereby holding the cables 18 to the support member. In other instances, the cables 18 may be passed through the openings 74, 76 of the first and second channels 22, 26 before one or both of the first coupling member 30 or the second coupling members 34 of the clamp 10 is coupled to the support member. Furthermore, the clamp 10 may hold at least one cable 18 in either of the first or second channels 22, 26, and either one or both of the first and second coupling members 30, 34 may engage a support member.

The clamp secures cables to a structure (e.g., a PV module frame—not shown). The nylon body of the clamp reduces the risk of damage to the insulation of the cables. The multiple portions of the channels are capable of receiving cables of different sizes. The first and second coupling members allow the clamp to be secured to a structure in various orientations.

The embodiments described above and illustrated in the figures are presented by way of example only and are not intended as a limitation upon the concepts and principles presented herein. As such, it will be appreciated that variations and modifications exist within the scope and spirit of one or more independent aspects as described.

What is claimed is:

1. A clamp comprising:
a body including a first end and a second end, the body further including a first side and a second side, the first side extending between the first end and the second end, a longitudinal axis extending between the first end and the second end;
a channel extending through the body in a direction transverse to the longitudinal axis, the channel including a plurality of curved inner surfaces having different radii of curvature, the channel positioned adjacent the first end;
an opening extending between the first end of the body and the channel, the opening configured to permit a portion of a cable to be laterally inserted into the channel; and
a clamping member positioned adjacent the first side of the body and capable of engaging a support member, the clamping member configured to bias the support member against the first side.

2. The clamp of claim 1, wherein the clamping member exerts a clamping force against the first side along a line that is parallel to the longitudinal axis.

3. The clamp of claim 1, wherein the clamping member exerts a clamping force against the second side along a line that is perpendicular to the longitudinal axis.

4. The clamp of claim 1, wherein the clamping member is a first clamping member, further comprising a second clamping member positioned adjacent the second side of the body and capable of engaging a support member, the second clamping member configured to bias the support member against the second side.

5. The clamp of claim 4, wherein the first clamping member is oriented in a different direction than the second clamping member.

6. The clamp of claim 4, wherein one of the first clamping member and the second clamping member exerts a clamping force along a line that is parallel to the longitudinal axis, and the other of the first clamping member and the second clamping member exerts a clamping force along a line that is perpendicular to the longitudinal axis.

7. The clamp of claim 1, wherein the clamping member includes a connecting portion and a leg portion, the connecting portion connected to the body, the leg portion supported by the connecting portion in a cantilevered manner.

8. The clamp of claim 1, further comprising a plurality of projections protruding from the first side, the clamping member exerting a clamping force against the plurality of projections.

9. The clamp of claim 1, wherein the channel is a first channel and the opening is a first opening, further comprising,
a second channel extending through the body in a direction transverse to the longitudinal axis, the second channel including a plurality of curved inner surfaces having different radii of curvature, the second channel positioned adjacent the second end and substantially parallel to the first channel;
a second opening extending between the second end of the body and the second channel, the second opening configured to permit a portion of a cable to be laterally inserted into the second channel.

10. The clamp of claim 1, wherein at least the body is fabricated from a nylon material.

11. A clamp comprising:
a body including a first end and a second end, the body further including a first side and a second side, the first side extending between the first end and the second end, a longitudinal axis extending between the first end and the second end;
a first channel extending through the body in a direction transverse to the longitudinal axis, the first channel positioned adjacent the first end;
a first opening extending between the first end of the body and the first channel, the first opening configured to permit a portion of a cable to be laterally inserted into the first channel;
a second channel extending through the body in a direction transverse to the longitudinal axis, the second channel positioned adjacent the second end and substantially parallel to the first channel;
a second opening extending between the second end of the body and the second channel, the second opening configured to permit a portion of a cable to be laterally inserted into the second channel;
a first clamping member positioned adjacent the first side of the body and exerting a biasing force against the first side; and
a second clamping member positioned adjacent the second side of the body and exerting a biasing force against the second side.

12. The clamp of claim 11, wherein at least one of the first clamping member and the second clamping member exerts the respective biasing force along a line that is parallel to the longitudinal axis.

13. The clamp of claim 11, wherein at least one of the first clamping member and the second clamping member exerts the respective biasing force along a line that is perpendicular to the longitudinal axis.

14. The clamp of claim 11, wherein the first clamping member is oriented in a different direction than the second clamping member.

15. The clamp of claim 11, wherein the first clamping member exerts the biasing force against the first side along a line that is parallel to the longitudinal axis, and the second clamping member exerts the biasing force against the second side along a line that is perpendicular to the longitudinal axis.

16. The clamp of claim 11, wherein the first clamping member includes a connecting portion and a leg portion, the connecting portion connected to the body, the leg portion supported by the connecting portion in a cantilevered manner.

17. The clamp of claim 11, wherein the connecting portion is connected to the first side.

18. The clamp of claim 11, further comprising a plurality of first projections protruding from the first side, the clamping member exerting the biasing force against the plurality of first projections.

19. The clamp of claim 11, wherein the first channel and the second channel each include a plurality of curved inner surfaces, at least some of the curved inner surfaces having different radii of curvature.

20. The clamp of claim 11, wherein at least the body, the first clamping member, and the second clamping member is fabricated from a nylon material.
